(19) United States
(12) Patent Application Publication
(10) Pub. No.: US 2022/0026778 A1
(43) Pub. Date: Jan. 27, 2022

(54) HIGH-POWER DYNAMIC LENS FOR ADDITIVE MANUFACTURING

(71) Applicant: MAGNA INTERNATIONAL INC., Aurora (CA)

(72) Inventors: Todd DEAVILLE, Markham (CA); Vito ABATE, Etobicoke (CA)

(21) Appl. No.: 17/297,218

(22) PCT Filed: Nov. 26, 2019
(86) PCT No.: PCT/CA2019/051690

§ 371 Date: May 26, 2021

Related U.S. Application Data
(60) Provisional application No. 62/771,255, filed on Nov. 26, 2018.

(51) Int. Cl. G02F 1/29; B23K 26/06

(52) U.S. Cl. CPC G02F 1/291; B23K 26/0648; B33Y 30/00; G02F 2203/01; G02F 2203/50; B23K 26/0643

(57) ABSTRACT

A dynamic lens for projecting different output beam shapes upon a target for heating, melting, or otherwise modifying the state of the target material. The dynamic lens includes a first light source of high power laser diodes generating a first light beam onto a lensing array with an LCOS device including a plurality of liquid crystal cells to curve and focus the first light beam into a second light beam forming the output beam shape on the target. A controller generates a control signal corresponding to the output beam shape. A single-point laser projects a third light beam tracing an outline of the output beam shape on the target to more clearly define the edge of the output beam shape. The single-point laser may be an IR fiber laser source scanned or traced by a scanner, such as a galvano scanner, directing the third light beam in two dimensions.

### CROSS-REFERENCE TO RELATED APPLICATION

This PCT International Patent Application claims the benefit of and priority to U.S. Provisional Patent Application Ser. No. 62/771,255, filed on Nov. 26, 2018, titled “High-Power Dynamic Lens for Additive Manufacturing,” the entire disclosure of which is hereby incorporated by reference.

### FIELD

The present disclosure relates generally to a dynamic lens for projecting different output beam shapes upon a target.

### BACKGROUND

Lenses are used in various applications including forming a high-power light beam into an output beam shape on a target for applications such as welding and additive manufacturing (“AM”). Such lenses must be able to withstand exposure to high-power light beams through a large number of cycles or pulses throughout the lifetime of the lens. Dynamic type lenses are capable of changing to form a light beam into different shapes. Thus far, dynamic lenses have not been suitable for high-power applications because available dynamic lenses have required electrodes or other fragile materials that are damaged by the high-power light beams passing therethrough.

### SUMMARY

The present disclosure provides a dynamic lens for projecting different output beam shapes upon a target for the purpose of melting, fusing, or otherwise changing the material state.

The dynamic lens includes a first light source generating a first light beam, and a lensing array including a plurality of liquid crystal cells each configured to modulate a phase of the first light beam in response to an electrical stimulation. The liquid crystal cells of the lensing array are configured to operate in conjunction to curve and focus the first light beam into a second light beam forming an output beam shape on a target.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1A is a schematic diagram of a dynamic lens according to an aspect of the present disclosure,

FIG. 1B is a cut-away view of the schematic diagram of FIG. 1A, showing a first light beam at section A-A;

FIG. 1C is a cut-away view of the schematic diagram of FIG. 1A, showing a second light beam at section B-B with a representation of the transformation of the first light beam by the lensing array to form the output beam shape;

FIG. 1D is a cut-away view of the schematic diagram of FIG. 1A, showing the second light beam defining the output beam shape at section C-C;

FIG. 2A is a schematic diagram of a dynamic lens according to another aspect of the present disclosure,

FIG. 2B is a cut-away view of the schematic diagram of FIG. 2A, showing a first light beam at section A-A;

FIG. 2C is a cut-away view of the schematic diagram of FIG. 2A, showing a second light beam at section B-B with a representation of the transformation of the first light beam by the lensing array to form the output beam shape;

FIG. 2D is a cut-away view of the schematic diagram of FIG. 2A, showing the second light beam defining the output beam shape at section C-C;

FIG. 3 is another schematic view of liquid crystal cells curving a light beam passing therethrough;

FIG. 4A is a cut-away schematic view of liquid crystal cells in an LCOS device curving a light beam passing therethrough;

FIG. 4B is a cut-away schematic view of liquid crystal cells in the LCOS device curving a light beam passing therethrough;

FIG. 5 a graphic representation of a redistribution surface/map for stimulating the liquid crystal cell within the lensing array;

FIG. 6 is a output image generated as a result of light being curved and focused by a lensing array stimulated according to the redistribution surface/map of FIG. 5;

FIG. 7 is a diagram of a lensing array including a plurality of LCOS devices;

FIG. 8 is a schematic diagram of a machine including a dynamic lens according to an aspect of the disclosure; and

FIG. 9 is a flow chart listing steps in a method of operating a dynamic lens.

### DETAILED DESCRIPTION

Recurring features are marked with identical reference numerals in the figures, in which example embodiments of a dynamic lens for projecting a plurality of different output beam shapes upon a target, and a method of operating such a dynamic lens are disclosed.

The system and method of the present disclosure therefore provides for an output beam shape which is dynamically adjustable, meaning its shape and points of focus can be quickly changed. The invention also provides for an output beam with substantially all of the first light beam transmitted to the target. This is an improvement over prior art “masking” type beam former which mask or direct a portion of the first light beam away from the target in order to create a desired beam shape.

A dynamic lens according to the present invention allows for targets or frames that vary in size within the limits of the size of the lensing array. A dynamic lens also allows for variable power density depending on frame size. This means that frame size may increase as part density decreases. Also, unlike systems that employ adaptive masks, the build rate on AM systems using a dynamic lens is not dependent on part density (frame utilization).

Numerous applications can be envisioned for a high-power dynamic lens that can form substantially all of a high-power light beam into a desired beam shape. A few such applications are plastic and composite welding, metal welding, conformal cooling for injection molds, conformal cooling for hot stamping molds, metal surface treatment (i.e., polishing, temper, local annealing), prototyping, low—medium production volume replacement process for lightweight structural components (i.e., casting; composites). Such a high-power dynamic lens may have applications in many industries including, for example, automotive, aerospace production (brackets, nozzles, pump housings, etc.), military (field repair/service), medical implants, and prototyping.

Referring to the Figures, wherein like numerals indicate corresponding parts throughout the several views, a dynamic lens 20 for projecting a plurality of different output beam shapes 22 upon a target 24 is generally shown. The dynamic lens 20 includes a first light source generating a first light beam 30. The first light source 26 may include one or more laser diodes 28. Alternatively or additionally, the first light source 26 may include one or more pulsed green fiber lasers, which may output laser light having a wavelength of about 532 nm. The first light source 26 may output a high-power of at least approximately 10 kW. The first light source 26 may output a lower power of less than 10 kW, for example, when starting. The dynamic lens 20 of the present invention could be used with first light beams 30 having a wide range of power, from 100 W to greater than 100 kW.

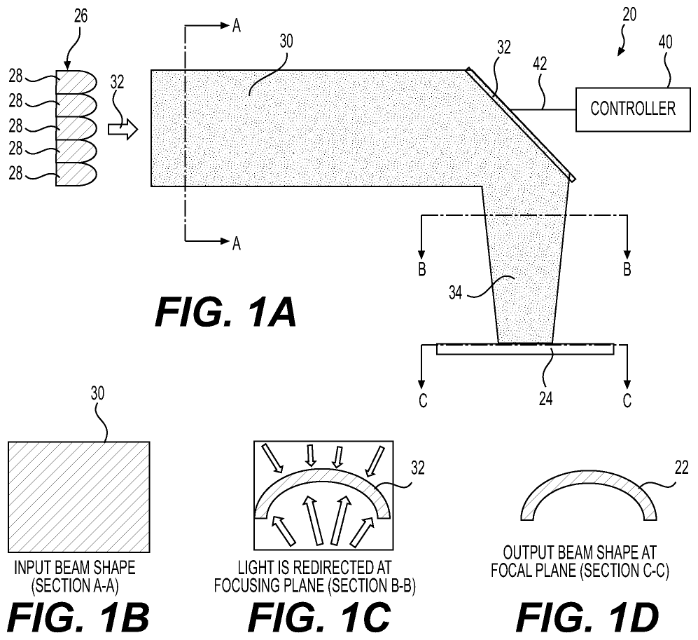

As shown in FIG. 1A, the first light beam 30 is directed from the first light source 26 and onto a lensing array 32, which curves and focuses the first light beam 30 into a second light beam 34 forming the output beam shape 22 on the target 24. The lensing array 32 includes a plurality of liquid crystal cells 36 each configured to modulate a phase of the first light beam 30 in response to an electrical stimulation. In other words, the liquid crystal cells 36 of the lensing array 32 are configured to operate in conjunction together to curve and focus the first light beam 30 into a second light beam 34 forming the output beam shape 22 on the target 24. The target 24 may be flat or contoured and some or all of the target 24 may be disposed at an acute or obtuse angle to the path of the second light beam 34. The dynamic lens 20 may also include one or more optical components such as lenses and filters.

A controller 40 generates a control signal 42 corresponding to the output beam shape 22 and communicates the control signal 42 to the lensing array 32. The control signal 42 may be static and remain fixed to cause the output beam shape 22 to remain constant. Such a configuration may be used, for example, in additive manufacturing (“AM”) applications where the output beam shape 22 is used to create parts having predetermined shapes. Alternatively, the control signal 42 and the output beam shape 22 may be dynamically generated, such as in rapid prototyping additive manufacturing or in applications where the output beam shape 22 is used to weld parts which may have differing contours, distances, and/or orientation from the focusing plane 48.

In an example embodiment, the lensing array 32 may include one or more liquid crystal on silicon (LCOS) devices 46, each including an array of the liquid crystal cells 36 disposed on a silicon backplate 48. In another example embodiment, and as shown on FIG. 7, the lensing array 32 may include a plurality of LCOS devices 46. More specifically, the lensing array 32 may include an array of the LCOS devices 46, which may have a regular pattern such as straight rows and columns as shown on FIG. 7. The lensing array 32 may include the LCOS devices 46 in another pattern or physical layout, such as in offset rows, or with different shapes, which may form an interlocking regular pattern.

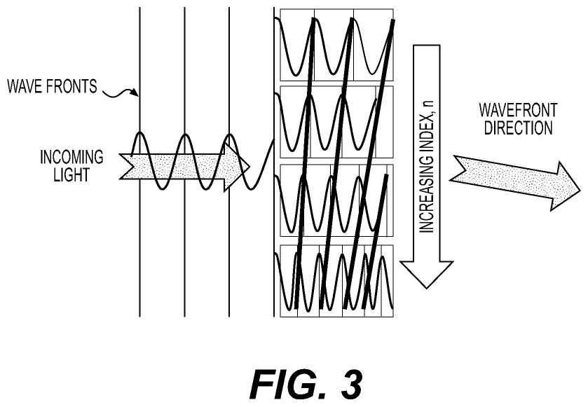

As shown on FIG. 3, liquid crystal cells 36 can be used to modulate the phase of the light wave passing through them. This is possible since liquid crystals 36 are birefringent materials, that is, they have two orthogonal indices of refraction. Changing the orientation of the liquid crystals by application of an electric field allows the index of refraction and thus the light bending capability of the liquid crystal to vary between the two different indices of refraction.

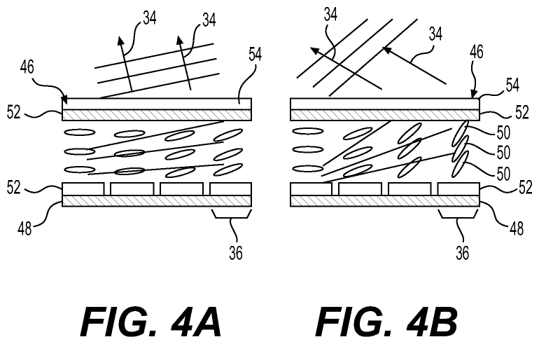

As illustrated on FIG. 4A and 4B, an LCOS device 46 includes a plurality of liquid crystal cells 36 each disposed upon a silicon backplate 48. Each of the liquid crystal cells 36 includes liquid crystals 50 that vary in orientation with an applied electric field as generated by a voltage applied between two electrodes 52. A transparent layer 54, such as glass or plastic, may be disposed over the liquid crystal cells 36 to provide structural rigidity, to contain the liquid crystals 50, and to support one of the electrodes 52. FIGS. 4A and 4B illustrate liquid crystal cells 36 in two different states, causing the second light beam 34 reflecting therefrom to be directed in different directions.

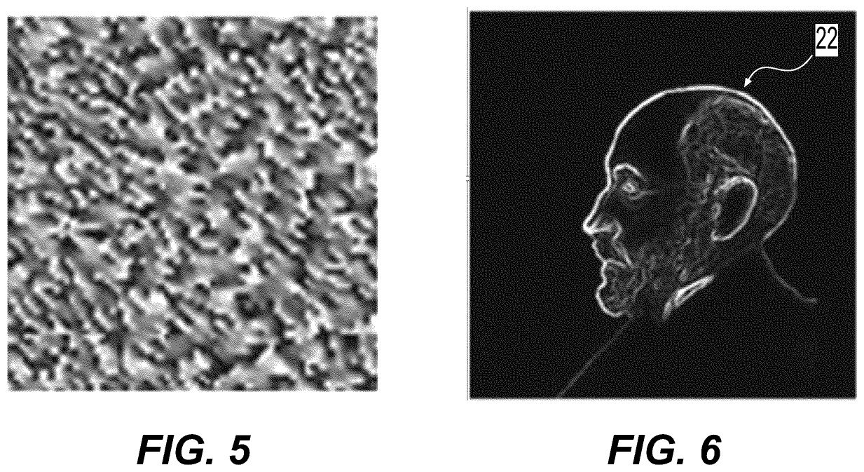

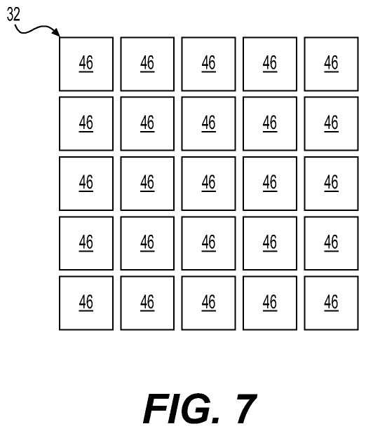

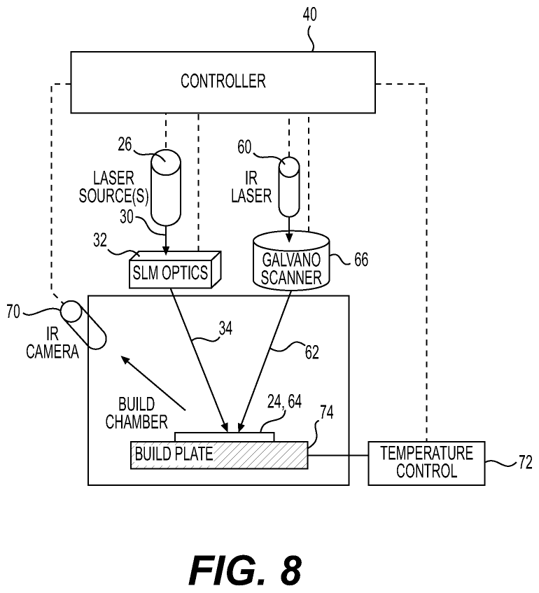

As illustrated in FIGS. 5 and 6, a redistribution surface map may be used to control the electrical current on each of the liquid crystal cells 36 in the lensing array 32, which causes the lensing array 32 to define the corresponding output beam shape 22 in the third light beam 34.

In an exemplary embodiment, each of the LCOS devices 46 may be configured to focus the second light beam 34 onto a corresponding, or dedicated region of the target 24. Alternatively, two or more of the LCOS devices 46 in the lensing array 32 are each configured to focus the second light beam 34 onto an overlapping region of the target 24.

In an exemplary embodiment where the first light source 26 includes a plurality of illumination elements, such as laser diodes 28, or other bulbs or light sources, each of the illumination elements may be configured to illuminate a corresponding one of the LCOS devices 46 in the lensing array 32. In other words, there may be some correspondence between the illumination elements and the LCOS devices 46. Such a correspondence may also be one illumination source associated with a group of two or more of the LCOS devices 46 or two or more illumination sources being associated with a particular one of the LCOS devices 46. Alternatively, a single illumination source in the first light source 26 may be configured to illuminate all of the LCOS devices 46 in the lensing array 32. The illumination sources may include one or more lenses to focus the light therefrom primarily onto a corresponding one or ones of the LCOS devices 46 in the lensing array 32.

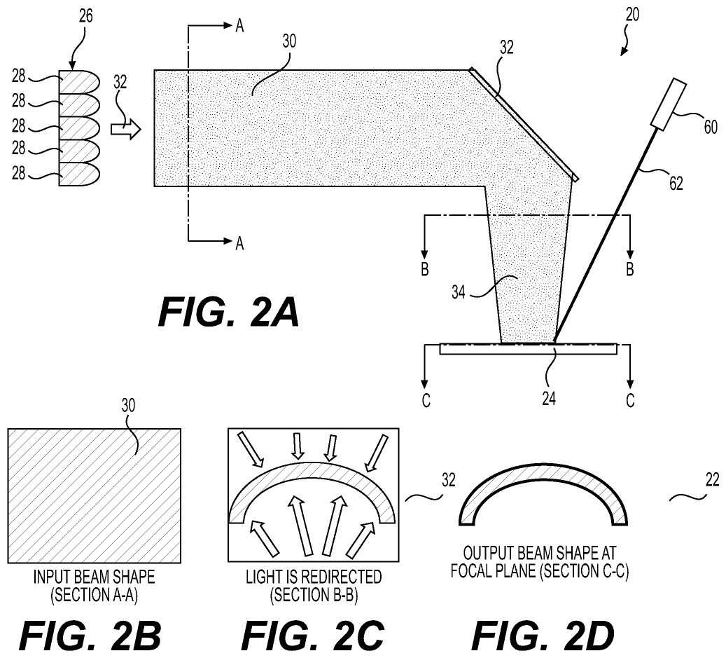

In an aspect of the disclosure, and as shown in the embodiment of FIG. 2A, the dynamic lens 20 may also include a single-point laser 60 independent of the first light source 26 and configured project a third light beam 62 tracing an outline 64 of the output beam shape 22 on the target 24. The outline 64 may help to more clearly define the edge of the output beam shape 22. In additive manufacturing applications, it may provide for a smoother edge of the part being made. The single-point laser 60 may be an IR fiber laser source, and may generate the third light beam 62 with a wavelength of 1064 nm. The third light beam 62 may be scanned or traced by a scanner 66, such as a Galvano scanner, which may function to direct the third light beam 52 in two dimensions. The scanner 66 and/or the single-point laser 50 may be directed by the controller 40.

In some embodiments, the dynamic lens 20 may also include two or more single-point lasers 60, each independent of the first light source 26 and each configured project a third light beam 62, and together tracing the outline 64 of the output beam shape 22 on the target 24. In some embodiments, there may be a scanner 66, such as a Galvano scanner, associated with each of the single-point lasers 60.

Because the lensing array 32 focuses the first light beam 30 to form the output beam shape 22 instead of masking or filtering a portion of the first light beam 30, as is done in systems of the prior art, substantially all of the first light beam 30 is transmitted to the target 24 in the form of the second light beam 34. This provides for improved efficiency and higher throughput.

The dynamic lens 20 of the present disclosure may also include one or more feedback devices, such as an IR camera 70 and/or a temperature controller 72 to provide for adaptive feedback control of the power level and distribution of energy on the target 24. This adaptive feedback may to provide several advantages for a variety of applications. For example, adaptive feedback may be used in welding or additive manufacturing applications to provide dimensional control and to optimize process speed. Adaptive feedback may be particularly useful in additive manufacturing applications to compensate for non-uniformities in the shape and size of powder media and/or to control a surface finish. Adaptive feedback control may also be useful to control final material properties, for example, by controlling a heating and/or cooling rate to control grain sizes in the part. In some embodiments, the temperature controller 72 may monitor one or more temperatures of the target 24 and/or a baseplate 74 holding the target 24. For example, the temperature controller 72 may include circuitry to monitor one or more thermocouples 72 embedded within the baseplate 74. In other embodiments, the temperature controller 72 may actively control heating and/or cooling of the target 24 and/or the baseplate 74.

Two or more dynamic lenses 20 may be combined serially to further resolve the output beam shapes 22 upon the target 24.

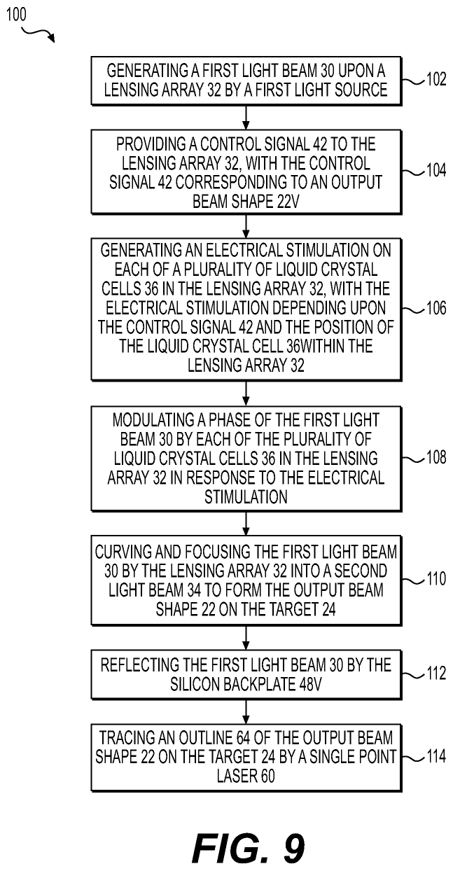

As described in the flow chart of FIG. 9, a method 100 of operating a dynamic lens 20 to generate an output beam shape 22. The method 100 includes the step of 102 generating a first light beam 30 upon a lensing array 32 by a first light source 26. This step may be performed by one or more laser diodes 28, pulsed green fiber lasers, or another light source. This step may also including focusing or directing the first light beam 30, for example by one or more lenses, mirrors, prisms, etc.

The method 100 also includes 104 providing a control signal 42 to the lensing array 32, with the control signal 42 corresponding to an output beam shape 22. The control signal 42 may take the form of an electrical or optical signal and may be static or changing over time, such as with a video signal. The control signal 42 may be communicated digitally, analog, or a combination thereof, for example, using a digital to analog (D/A) or an analog to digital (A/D) converter.

The method 100 also includes 106 generating an electrical stimulation on each of a plurality of liquid crystal cells 36 in the lensing array 32, with the electrical stimulation depending upon the control signal 42 and the position of the liquid crystal cell 36 within the lensing array 32. The electrical stimulation may take the form of a DC voltage between electrodes 52 in or near each of the liquid crystal cells 36.

The method 100 also includes 108 modulating a phase of the first light beam 30 by each of the plurality of liquid crystal cells 36 in the lensing array 32 in response to the electrical stimulation. This step may include any modulation of the first light beam 30 the liquid crystal cells 36, including changes to the wavefront direction and/or to a polarity of the light beam 30. It may be performed by two subsequent transmissions of the first light beam 30 through the liquid crystal cells 36, such as where the first light beam 30 passes through the liquid crystal cells 36, reflects off of a reflective surface, such as a silicon backplate 48, and where it passes through the liquid crystal cells 36 a second time.

The method 100 also includes 110 curving and focusing the first light beam 30 by the lensing array 32 into a second light beam 34 to form the output beam shape 22 on the target 24. This step may include using a redistribution surface map or a phase mask, such as the example shown on FIG. 5, to control the electrical current on each of the liquid crystal cells 36 in the lensing array 32. This in turn causes the lensing array 32 to morph the first light beam 30 such that it defines the corresponding output beam shape 22 in the third light beam 34. FIG. 6 shows an example output beam shape 22 generated by the example phase mask shown on FIG. 5.

In an example embodiment, the lensing array 32 may also include the liquid crystal cells 36 each being disposed upon a silicon backplate 48, and the method the method 100 may also include 112 reflecting the first light beam 30 by the silicon backplate 48. This configuration is shown in FIGS. 4A and 4B, and in FIGS. 1-2. Alternatively, the lensing array 32 may include the liquid crystal cells 36 all being on a transparent substrate that curves and focuses the first light beam 30 as it passes through.

In an aspect of the disclosure, the method 110 may also include the step of 114 tracing an outline 64 of the output beam shape 22 on the target 24 by a single-point laser 60. This step map be performed using a scanner 66, such as a Galvano Scanner which may function to direct the third light beam 52 in two dimensions. The scanner 66 and/or the single-point laser 50 may be directed by the controller 40, which may include special-purpose hardware and/or software, such as a digital signal processor (DSP) and field programmable gate array (FPGA) as shown in FIG. 8.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Many modifications and variations of the present invention are possible in light of the above teachings and may be practiced otherwise than as specifically described while within the scope of the appended claims. These antecedent recitations should be interpreted to cover any combination in which the inventive novelty exercises its utility.

1. A dynamic lens comprising:
a first light source generating a first light beam;
a lensing array including a plurality of liquid crystal cells each configured to modulate a phase of the first light beam in response to an electrical stimulation;
said liquid crystal cells configured to operate in conjunction together to curve and focus said first light beam into a second light beam forming an output beam shape on a target.

2. The dynamic lens of claim 1, wherein said first light source includes a plurality of laser diodes generating said first light beam at a high-power of at least approximately 10 Kw.

3. The dynamic lens of claim 1, wherein said lensing array includes an LCOS device with said array of liquid crystal cells being disposed on a silicon backplate.

4. The dynamic lens of claim 3, wherein said lensing array includes a plurality of LCOS devices.

5. The dynamic lens of claim 4, wherein each of said LCOS devices is configured to focus said second light beam onto a corresponding region of the target.

6. The dynamic lens of claim 4, wherein two or more of said LCOS devices in said lensing array are each configured to focus said second light beam onto an overlapping region of the target.

7. The dynamic lens of claim 4, wherein said first light source includes a plurality of illumination elements; and
wherein each of said illumination elements is configured to illuminate a corresponding one of said LCOS devices in said lensing array.

8. The dynamic lens of claim 4, wherein said first light source is configured to illuminate all of said LCOS devices in said lensing array.

9. The dynamic lens of claim 1, further comprising a single-point laser independent of said first light source and configured to trace an outline of the output beam shape on the target.

10. The dynamic lens of claim 9, wherein said single-point laser is an IR fiber laser source.

11. The dynamic lens of claim 1, wherein said first light source includes one or more pulsed green fiber laser sources.

12. A method of operating a dynamic lens comprising:
generating a first light beam upon a lensing array by a first light source;
providing a control signal to the lensing array, with the control signal corresponding to an output beam shape;
generating an electrical stimulation on each of a plurality of liquid crystal cells in the lensing array, with the electrical stimulation depending upon the control signal and the position of the liquid crystal cell within the lensing array;
modulating a phase of the first light beam by each of the plurality of liquid crystal cells in the lensing array in response to the electrical stimulation;
curving and focusing the first light beam by the lensing array into a second light beam to form the output beam shape on a target.

13. The method of operating a dynamic lens of claim 12, wherein said lensing array includes the liquid crystal cells each being disposed upon a silicon backplate, and further comprising:
reflecting the first light beam by the silicon backplate.

14. The method of operating a dynamic lens of claim 12, further comprising:
tracing an outline of the output beam shape on the target by a single-point laser.

15. The method of operating a dynamic lens of claim 14, wherein tracing the outline of the output beam shape on the target by the single-point laser includes directing a light beam from the single-point laser in two dimensions by a galvano scanner.

16. The method of claim 14, wherein said single-point laser is an IR fiber laser source.

17. The method of claim 12, wherein said first light source includes one or more pulsed green fiber laser sources.

18. The dynamic lens of claim 9, further comprising a scanner configured to trace the outline of the output beam shape on the target in two dimensions.

19. The dynamic lens of claim 9, wherein the single-point laser is one of two or more single-point lasers together configured to trace the outline of the output beam shape on the target.

20. The dynamic lens of claim 19, further comprising a scanner associated with each of the two or more two or more single-point lasers and configured to direct a light beam from the associated one of the of the two or more two or more single-point lasers onto the target.
